(19) United States
(12) Patent Application Publication
(10) Pub. No.: US 2010/0125557 A1
(43) Pub. Date: May 20, 2010

(54) ORIGINATION BASED CONFLICT DETECTION IN PEER-TO-PEER REPLICATION

(75) Inventors: Rui Wang, Redmond, WA (US); Qun Guo, Redmond, WA (US); Peng Song, Issaquah, WA (US); Dennis Michael Tighe, Seattle, WA (US); Gopal Ashok, Bellevue, WA (US); Michael E. Habben, Sammamish, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/272,382

(22) Filed: Nov. 17, 2008

(51) Int. Cl. G06F 17/30; G06F 7/00

(52) U.S. Cl. 707/690; 707/E17.009

(57) ABSTRACT

Systems and methods that enable conflict detection in a peer-to-peer replication by embedding origination information in data records. A tracing component can track embedded information in form of peer ID and transaction ID, wherein conflicts can be detected by comparing a pre-version (prior to current version) of data on the source node—with—a current version of the data on the destination node.

### BACKGROUND

Advances in computer technology (e.g., microprocessor speed, memory capacity, data transfer bandwidth, software functionality, and the like) have generally contributed to increased computer application in various industries. Ever more powerful server systems, which are often configured as an array of servers, are commonly provided to service requests originating from external sources such as the World Wide Web, for example.

As the amount of available electronic data grows, it becomes more important to store such data in a manageable manner that facilitates user friendly and quick data searches and retrieval. Often a user stores the same information in more than one device or location, and replication, or synchronization, of data is a process typically employed to ensure that each data store has identical information. For example, a user can maintain an electronic address book or a set of email messages in a myriad of different devices or locations. Such user can further modify the contact information or send/receive email addresses using applications associated with each location. Regardless of where or how a change is made, a major goal of replication is to ensure that a change made on a particular device or in a particular location is ultimately reflected in other devices/stored locations.

One common replication method involves tracking changes that have occurred subsequent to a previous replication. For example, a device that seeks to replicate with another device can submit a request for changes to such other device. It is desirable that the changes that the other device sends are those that have occurred since the last replication. The device, or “replica,” that responds to a request for updated information can check for any changes that are time stamped subsequent to a previous replication. Any changes with such a time stamp can subsequently be sent to the device requesting replication. Typically, such replication requires that each replica be aware of the other replicas or the replication topology in which it is operating. Each replica can further maintain a record of what changes have been replicated on other replicas. In effect, each replica can maintain information about what it believes is stored on the other replicas within the topology.

The challenges of replication become more complicated when more than two replicas are included in the same sync community or topology. Among these challenges are problems involving replacing more current data with outdated data based on the order devices are replicated, replicating data that may already be in sync, and having data that is in sync be reported as being in conflict.

As one example, consider a sync community that includes three replicas. A user updates replica 1 at time 1. At time 2, the same data is updated in replica 2. Replica 2 then replicates with replica 3 and the changes made in replica 2 are incorporated into replica 3. If replica 3 subsequently receives changes from replica 1, the data originally updated on replica 2 may be replaced with the original data from replica 1, even though the change from replica 1 is not the most recent change.

Moreover, communication resources can be inefficiently allocated if replicas incorrectly believe that their information is out of sync, and hence perform unnecessary sync operations. In the three replica sync community example above, if a user updates replica 1, such changes can then replicated to replica 2. Replica 2 can then replicates its changes to replica 3, wherein information from replica 2 (which is currently also the information from replica 1) is changed on replica 3. Likewise, replica 3 can then replicate with replica 1. In some cases, replica 3 may know that replica 1 has been updated—yet not know the version of information on replica 1. As such, replica 3 may replicate its information to replica 1, even though the same information is already on replica 1. Further, additional needless replications may continue as replica 1 replicates with replica 2 or performs other pair-wise replications at subsequent times.

Other replication challenges involve replicated data that actually appear as being in conflict, even when no actual conflict exists. In the example given above, initially information on replica 1 can be updated and replicated to replica 2. Subsequently, the information on replica 1 can then be replicated to replica 3. Replicas 2 and 3 then attempt a replication only to discover that they each have changes (from the replication with replica 1) that have occurred since their last replication. Even though the changes are the same, nonetheless replicas 2 and 3 may conclude that a conflict exists.

### SUMMARY

The following presents a simplified summary in order to provide a basic understanding of some aspects described herein. This summary is not an extensive overview of the claimed subject matter. It is intended to neither identify key or critical elements of the claimed subject matter nor delineate the scope thereof. Its sole purpose is to present some concepts in a simplified form as a prelude to the more detailed description that is presented later.

The subject innovation detects conflicts in a peer-to-peer replication by embedding origination information in data records, in form of a peer ID (identifying a peer) and transaction ID (identifying the transaction changes to such record that resulted in current version of the data record). Such transaction ID is a unique ID that identifies a transaction on a peer and is relative/local thereto (as opposed to being globally unique and relative to space of all peers). Accordingly, transactions for each node can be paired thereto, and hence a transaction is distinct from another transaction for the same node in the topology (relative to each peer rather than the universe of peers). Each peer can log data changes that are transferable to another peer in an asynchronous mode. Moreover, no centralized control exists and each peer is responsible for logging changes made as part thereof. In a related aspect, the peer ID and the transaction ID can represent an additional column in data records, which can be hidden, and hence not exposed to applications nor addressed thereby. Furthermore, any new node has a unique ID in the history of the topology, and hence identification remains unique throughout universe of nodes in such topology. Users can collect all reported conflicts and derive the origination and the history of conflicting changes.

According to one particular aspect, during data replication from a source node to a target node conflicts can be detected by comparing a pre-version (prior to current version) of data on the source node—with—a current version of the data on the destination node. If no match exists, a conflict can then be detected. Such conflict detection can then be supplied to a user for a subsequent conflict resolution. As such, the origination information employed in the subject innovation mitigates a requirement of employing substantially large amount of space/overhead, and further enables peers not directly involved in the conflict to notice and report such violations upon replications thereto; (e.g., an “every where” detection, wherein as long as conflicting updates are applied/replicated to a same peer, a peer reporting a conflict need not be a peer on which a conflicting update actually occurs, and there is no need for a centralized node to detect conflicts.) Based on the origination information and on all reported conflicts from all peers, users are able to derive the root conflicting updates and the history of conflicts, wherein no centralized monitoring is required.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 illustrates a block diagram of a replication system that embeds origination information in data records in form of a peer ID and transaction ID, according to an aspect of the subject innovation.

FIG. 2 illustrates a conflict detection based on origination information according to an aspect of the subject innovation.

FIG. 3 illustrates a block diagram of a peer-to-peer replication according to a further aspect of the subject innovation.

FIG. 4 illustrates an exemplary table that lists conflicts detectable according to various aspects of the subject innovation.

FIG. 5 illustrates a methodology of collecting reported conflicts based on embedded origination data.

FIG. 6 illustrates a related methodology of conflict detection by embedding origination information in data records.

FIG. 7 illustrates a tracing component that tracks down origination information on reported conflicts on all peers, to derive the root conflicting updates.

FIG. 8 illustrates an inference component that can facilitate designating peer ID and transaction ID.

FIG. 9 is a schematic block diagram of a sample-computing environment that can be employed as part of embedding origination information in accordance with an aspect of the subject innovation.

FIG. 10 illustrates an exemplary environment for implementing various aspects of the subject innovation.

### DETAILED DESCRIPTION

The various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

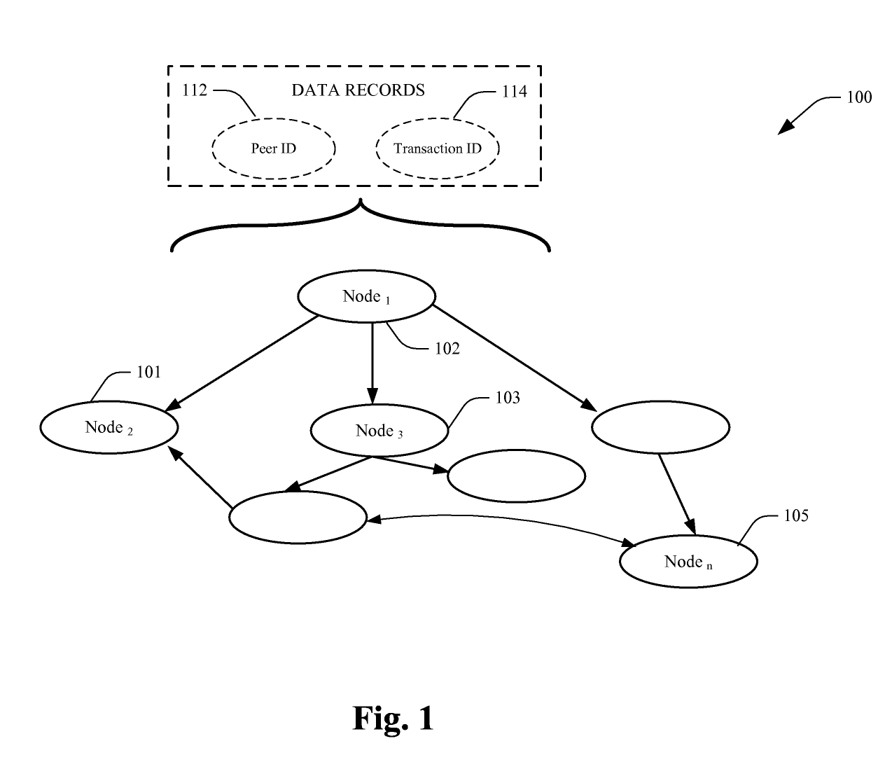

FIG. 1 illustrates a network 100 of nodes/endpoints representing a peer-to-peer replication/synchronization community that can detect conflicts by embedding origination information in data records, in form of a peer ID 112 and transaction ID 114. The peer ID 112 can employ a one-to-one mapping function defined from the value domain of the node identities to the nodes themselves, for identifying a peer. Likewise, the transaction ID 114 is a unique ID that identifies a transaction on a peer and is relative/local thereto (as opposed to being globally unique and relative to space of all peers). Accordingly, transactions for each node can be paired to such node, and hence a transaction is distinct from another transaction for the same node in the topology (relative to each peer rather than the universe of peers).

Each of the endpoints 101, 102, 103, 105 can be coupled to a respective replica through a communication link. In this sync community 100, although not all of the replicas are directly connected through communication links, changes in any of the replicas can be replicated to any of the other replicas within the sync community 100. In one aspect, the changes at any peer can be propagated asynchronously to all others by the peer-to-peer replication system.

For example, a change performed on an item in an endpoint can be associated with the peer ID 112, and the transaction ID 114—which can identify the ID of a replica and a version associated with that change. Moreover, the change ID can include designations, which further indicate such change is performed or associated with a replica and for a version associated therewith.

A replica that desires to synchronize its data with another replica—wherein a replica that desires to receive any changes it does not have from another replica—can additionally supply its transaction ID and replication during the replication process. The peer ID and the transaction ID can represent an additional column in data records, which can be hidden, and hence not exposed to applications and addressed thereby. Moreover, any new node has a unique ID in the history of the topology, and hence identification remains unique throughout universe of nodes in such topology. Users can collect all reported conflicts and derive the origination and the history of conflicting changes.

According to one particular aspect, during data replication from a source node to a target node conflicts can be detected by comparing a pre-version (prior to current version) of data on the source node—with—a current version of the data on the destination node. If no match exists, a conflict can then be detected. Such conflict detection can then be supplied to a user for a subsequent conflict resolution. As such, the origination information employed in the subject innovation mitigates a requirement of employing substantially large amount of space/overhead, and further enables peers not directly involved in the conflict to notice and report such violations upon replications thereto; (e.g., an “every where” detection, wherein as long as conflicting updates are applied/replicated to a same peer, a peer reporting a conflict need not be a peer on which a conflicting update actually occurs, and there is no need for a centralized node to detect conflicts.) Based on the origination information and on all reported conflicts from all peers, users are able to derive the root conflicting updates and the history of conflicts, wherein no centralized monitoring is required.)

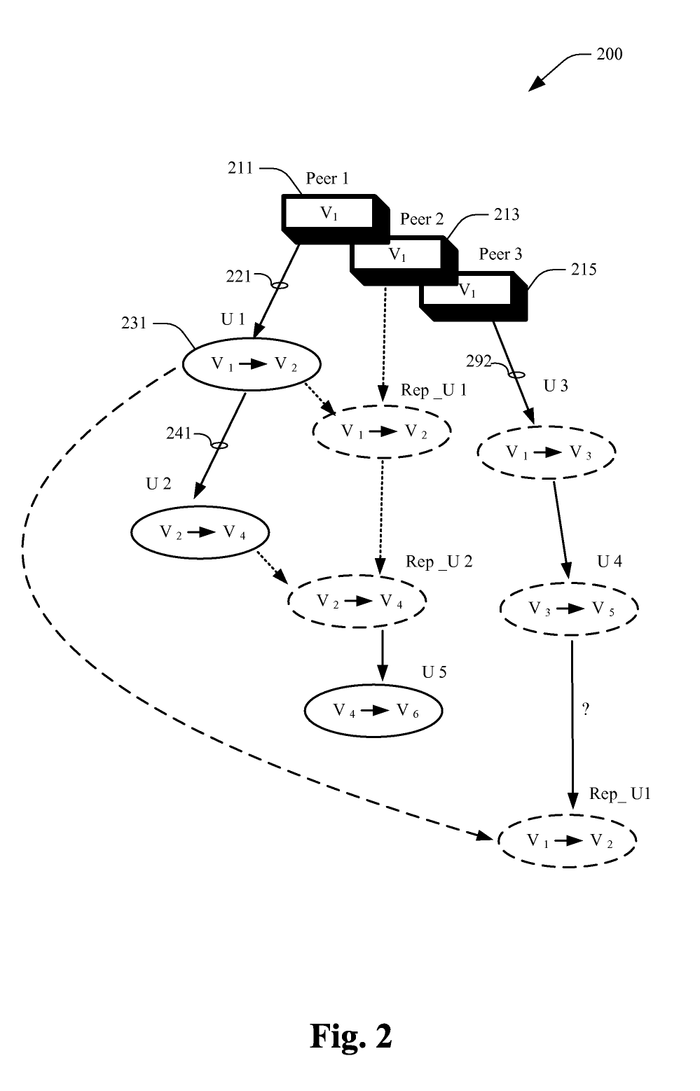

FIG. 2 illustrates an exemplary occurrence of conflicts 200 according to an exemplary aspect of the subject innovation. Even though such exemplary aspect 200 of conflict detection is primarily described in context of an update, it is to be appreciated that the conflict detection can also be applied in context of deletes and inserts. As illustrated in FIG. 2, three peers are Peer1, Peer2 and Peer3, 211, 213, 215 respectively, wherein each of such peers has one copy (in version V1) of the same data record.

By the update 221, U1 Peer 1 (211) updates its copy from V1 to V2 at 231; similarly, from V2 to V4, by U2 at 241. As such, U1 (221) and U2 (241) do not conflict, because they occur on the same peer and are serialized by the locking mechanism on Peer1.

Moreover, while Peer 1 (211) is making updates associated therewith, Peer 3 (215) also performs updates on its copy. Likewise, by U3 (292), Peer3 (215) updates its copy from V1 to V3. U1 (221) and U3 (292) conflict, because they make changes on the same data record (different copies) concurrently. U4 is considered conflicting with U2, since U4 makes a change upon a committed change of U3, which conflicts with U2. Similarly, U2 is considered conflicting with U3 and U4.

As indicated in FIG. 2, Rep_U1 represents replication of U1. When Rep_U1 is applied to Peer2, the data record is updated from V1 to V2. When Rep_U2 is applied to Peer2, the data record is updated further from V2 to V4. Likewise, by U5, Peer2 updates the data record from V4 to V6. U5 does not conflict with U2, because U5 makes a change upon a committed result of U2. U5 does not conflict with U1 either, because U5 makes a change upon the committed result of an update (U2), which does not conflict with U1.

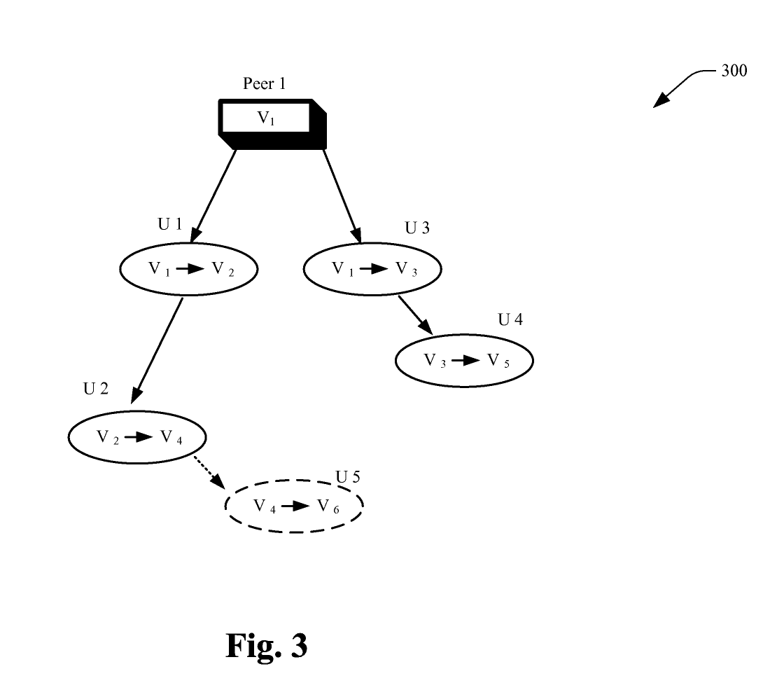

FIG. 3 illustrates user updates 300 assuming that: Rep_U1 has not been applied to Peer3; and collapsing copies of same version into one and removal of Rep1_Ux that represents replication of an update. As illustrated in FIG. 3, if two updates have an ancestor-offspring relation they do not conflict, and that two updates conflict if they do not have an ancestor-offspring relation. Accordingly, if all updates of a data record have ancestor-offspring relations, they are conflict-free. In a peer-to-peer replication environment, concurrent updates to different copies of the same data record are not prevented, thus possibly leading to conflicts.

Conflicts are detected when an update is replicated to another peer. As illustrated in FIG. 2, Rep_U1 carries both the pre-version (V1) and post-version (V2) of U1. When Rep_U1 is applied to Peer3, the current version of the data record is V5, which is different from the pre-version of Rep_U1, V1. Such indicates conflicting updates occurred to this data record. Moreover, an ancestor update is typically replicated to a peer earlier than any of its offspring updates. Hence, when a conflict is detected, one of the root conflicting updates is being replicated. As such, the root conflict between U1 and U3 is detected when U1 is replicated to Peer3. Similarly, it can be detected when U3 is replicated to Peer1 or Peer2.

The subject innovation enhances each data record in the topology with an origination column, which is implemented as a hidden column and not visible to usual user connections. Such origination column can be a concatenation of Originator ID (ORID) and Transaction ID (XDesID). As explained earlier, ORID is the ID of a peer in the topology. Such origination column indicates that this version of the data record results from an update by which peer and in which transaction on that peer. As long as ORID uniqueness is guaranteed, (e.g., no duplicate ORIDs and no reusing ORIDs) conflicts are never missed. A peer can thus change its ORID (to a new one different from any peer's ID in the topology's history) without compromising the functionality of conflict detection. When an update occurs, both the pre-version and the post-version of the data row being updated are logged, and will be picked up for replication.

Moreover, the conflict detection of the subject innovation with origination-enhanced data records has the following features, namely

1) Everywhere detection: After a conflict occurs, as long as the conflicting updates are applied (or replicated) to a same peer, this conflict will be detected. A peer reporting a conflict may not be a peer on which a conflicting update occurs. Hence, there exists no need for a centralized node to detect conflicts;

2) Traceability: Based on the origination information and on all reported conflicts from all peers, users are able to derive the root conflicting updates and the history of conflicts.

3) Lightweight: Enhancing data records with origination incurs substantially minor overhead in space and network communication. When a replicated update is applied to a destination peer, the CPU cost in comparing pre-origination with the current origination is modest.

With such features, conflict detection with origination-enhanced data records of the subject innovation supplies advantages over other techniques such as centralized detection (in terms of everywhere detection), GUID based detection (in terms of traceability) and version history based detection (in terms of lightweight). For example, conventional systems employing centralized detection creates the central node both a performance bottleneck and a single failure point. Likewise, in conventional systems employing a GUID that has a fixed size of 16 bytes, origination information is not contained. Moreover, conventional systems that employ a version history based mechanism, store and process the version history of data records and thus are able to resolve conflicts with guarantee of convergence, but may incur significant space, net work communication and CPU overhead—and hence such mechanism is not appropriate for systems expecting rare conflicts.

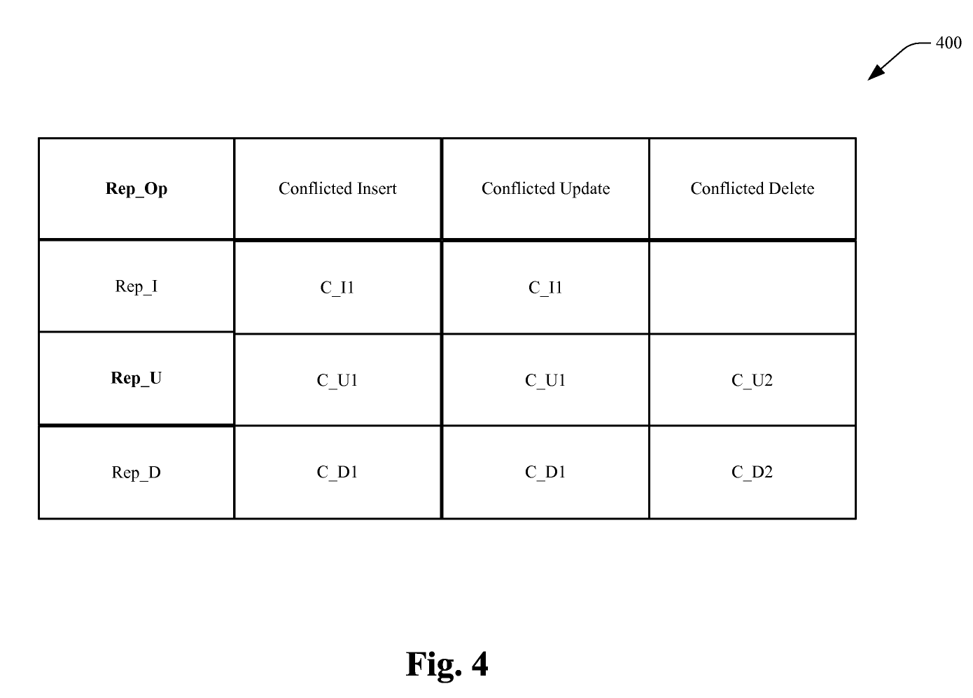

FIG. 4 illustrates an exemplary table 400 that lists conflict cases detectable according to various aspects of the subject innovation. In general, a data manipulation language (DML) operation can be an insert, a delete or an update. Moreover, conflict detection typically requires special handling when insert or delete is involved. FIG. 4 illustrates lists all conflict cases, wherein empty cells indicate no conflicts. It is to be appreciated that a table in a Peer-to-Peer replication topology typically has a primary key associated with its processes.

As illustrated in FIG. 4, when a Rep_Op is an update (Rep_U) or a delete (Rep_D), and if the destination peer has a data record with the same primary key, but with a different origination from the pre-origination of Rep_U (or Rep_D), it indicates that this replicated update (or delete) conflicts with another operation, either insert or update (case C_U1 or C_D1). Moreover, it is to be appreciated that a possibility exists that a replicated update/delete conflicts with an insert on the destination peer, (e.g., since the destination peer may have already deleted the data record and inserted another data record with the same primary key.) Otherwise, if the destination peer does not have a data record with the same primary key, such indicates that this replicated update or delete conflicts with a delete (case C_U2 or C_D2).

When a Rep_Op is an insert (Rep_1), which does not have a pre-origination, and if the destination peer has a data record with the same primary key, such indicates that this replicated insert conflicts with an insert or update (case C_I1).

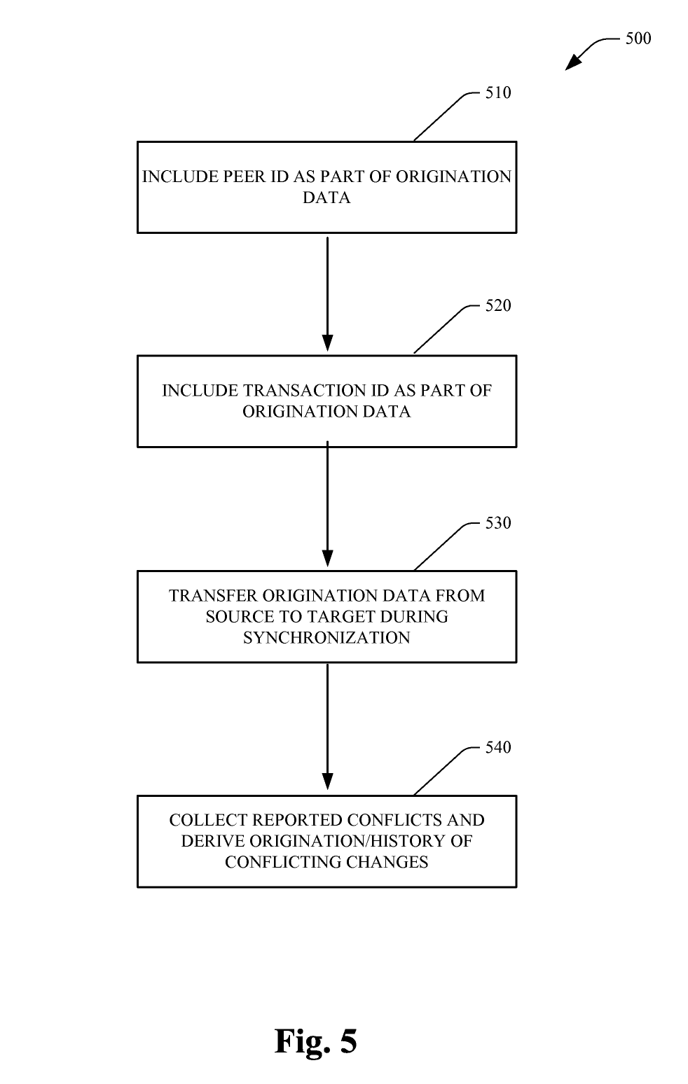

FIG. 5 illustrates a methodology 500 of collecting reported conflicts based on embedded origination data according to an aspect of the subject innovation. While the exemplary method is illustrated and described herein as a series of blocks representative of various events and/or acts, the subject innovation is not limited by the illustrated ordering of such blocks. For instance, some acts or events may occur in different orders and/or concurrently with other acts or events, apart from the ordering illustrated herein, in accordance with the innovation. In addition, not all illustrated blocks, events or acts, may be required to implement a methodology in accordance with the subject innovation. Moreover, it will be appreciated that the exemplary method and other methods according to the innovation may be implemented in association with the method illustrated and described herein, as well as in association with other systems and apparatus not illustrated or described. Initially and at 510, data related to peer ID is included as part of origination data, which can be embedded as origination information data records. Such peer ID can represent a unique ID in the history of the topology, and hence identification remains unique throughout universe of nodes in such topology. Likewise, and at 520 a transaction ID can be included as part of the origination data, wherein such transaction ID represents a unique ID that identifies a transaction on a peer and is relative/local thereto (as opposed to being globally unique and relative to space of all peers). Accordingly, transactions for each node can be paired thereto, and hence a transaction is distinct from another transaction for the same node in the topology (relative to each peer rather than the universe of peers). Subsequently, and at 530 each peer can log data changes that are transferable to another peer in an asynchronous mode. Hence, no centralized control exists and each peer is responsible for logging changes made as part thereof. For example, the peer ID and the transaction ID can represent an additional column in data records, which can be hidden, and hence not exposed to applications and addressed thereby. At 540 reported conflicts can be collected to derive the origination and the history of conflicting changes.

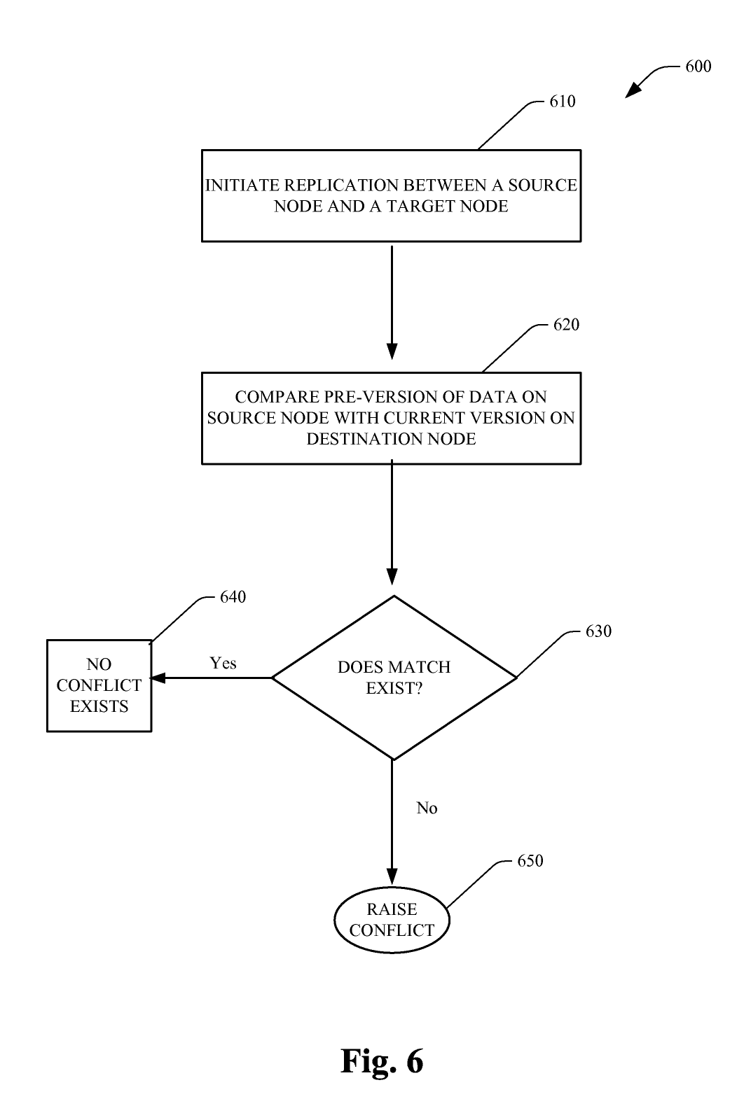

FIG. 6 illustrates a related methodology 600 of conflict detection by embedding origination information in data records, according to an aspect of the subject innovation. Initially and at 610, a replication can be initiated between a source node and a target node in peer-to-peer networked community. At 620, a comparison occurs between a pre-version (prior to current version) of data on the source node—with—a current version of the data on the destination node. If no match exists at 630, a conflict can then be detected and raised at 650, wherein such conflict detection can then be supplied to a user for a subsequent conflict resolution. Otherwise, and at 640 a determination is made that no conflict exists.

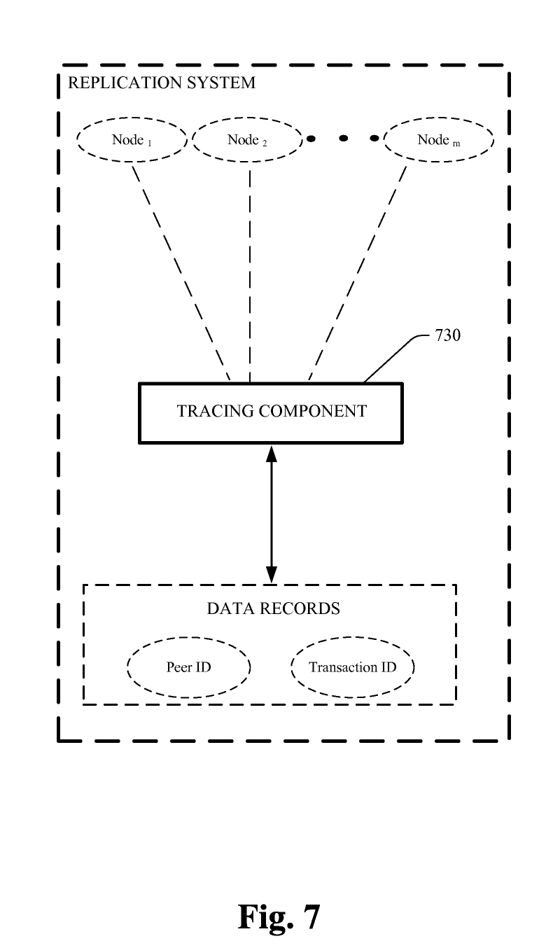

FIG. 7 illustrates a tracing component 730 that tracks down origination information on reported conflicts on all peers, to derive the root conflicting updates. Accordingly, an “every where” detection is enabled, wherein as long as conflicting updates are applied/replicated to a same peer, a peer reporting a conflict need not be a peer on which a conflicting update actually occurs, and there is no need for a centralized node to detect conflicts. In one aspect, the tracing component 730 examines origination information embedded in data records in form of a peer ID (which identifies a peer) and a transaction ID (which identifies transaction changes to such records relative to the peer).

For example, the tracing component 730 can detect and track back when an update is replicated to another peer, wherein when a conflict is detected, one of the root conflicting updates is being replicated. As explained earlier, the tracing component 730 can examine hidden columns in data records, which are not readily visible to usual user connections. For example, such origination column can indicate that such version of the data record results from an update by which peer and in which transaction on that peer. Hence, based on the origination information and on all reported conflicts from all peers, users are able to derive the root conflicting updates and the history of conflicts.

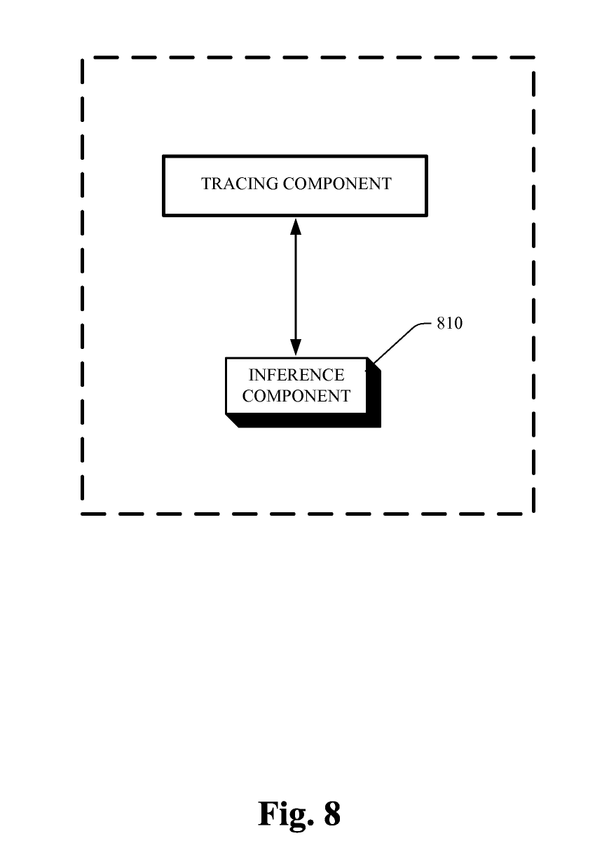

FIG. 8 illustrates an inference component 810 that can facilitate designating peer ID according to various aspects of the subject innovation. In one aspect, the inference component 810 can supply heuristics, which can be employed to embed origination information in data records. Moreover, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

The inference component 810 can employ any of a variety of suitable AI-based schemes as described supra in connection with facilitating various aspects of the herein described invention. For example, a process for learning explicitly or implicitly when to embed origination information in data records, can be facilitated via an automatic classification system and process. Classification can employ a probabilistic and/or statistical-based analysis (e.g., factoring into the analysis utilities and costs) to prognose or infer an action that a user desires to be automatically performed. For example, a support vector machine (SVM) classifier can be employed. Other classification approaches include Bayesian networks, decision trees, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information) so that the classifier is used to automatically determine according to a predetermined criteria which answer to return to a question. For example, with respect to SVM's that are well understood, SVM's are configured via a learning or training phase within a classifier constructor and feature selection module. A classifier is a function that maps an input attribute vector, x=(x1, x2, x3, x4, xn), to a confidence that the input belongs to a class—that is, f(x)=confidence(class).

As used in herein, the terms “component,” “system”, “module” and the like are intended to refer to a computer-related entity, either hardware, a combination of hardware and software, software or software in execution. For example, a component can be, but is not limited to being, a process running on a processor, a processor, an object, an instance, an executable, a thread of execution, a program and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner. It is to be appreciated that a myriad of additional or alternate examples could have been presented, but have been omitted for purposes of brevity.

Furthermore, all or portions of the subject innovation can be implemented as a system, method, apparatus, or article of manufacture using standard programming and/or engineering techniques to produce software, firmware, hardware or any combination thereof to control a computer to implement the disclosed innovation. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

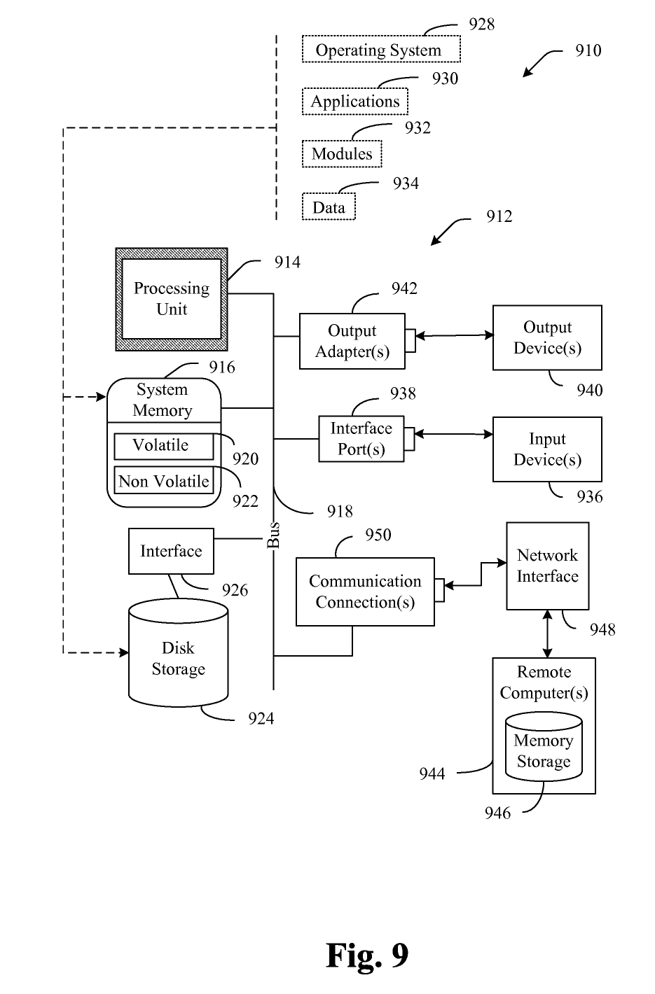

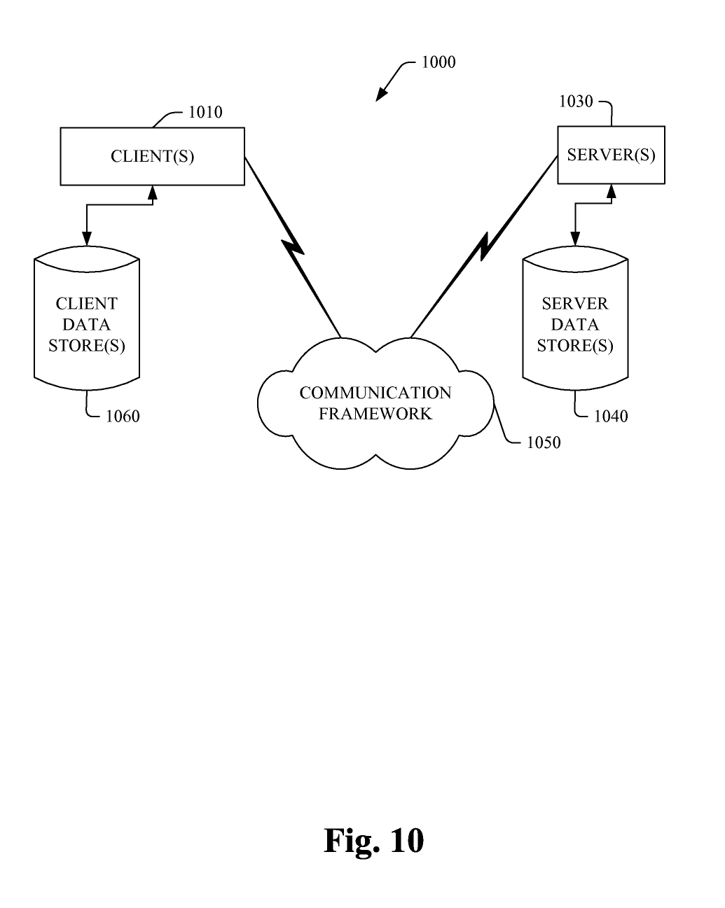

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the innovation also may be implemented in combination with other program modules. Generally, program modules include routines, programs, components, data structures, and the like, which perform particular tasks and/or implement particular abstract data types. Moreover, those skilled in the art will appreciate that the innovative methods can be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the innovation can be practiced on stand-alone computers. In a distributed computing environment, program modules may be located in both local and remote memory storage devices.

With reference to FIG. 9, an exemplary environment 910 for implementing various aspects of the subject innovation is described that includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/non-removable, volatile/non-volatile computer storage media. FIG. 9 illustrates a disk storage 924, wherein such disk storage 924 includes, but is not limited to, devices like a magnetic disk drive, floppy disk drive, tape drive, Jaz drive, Zip drive, LS-60 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that various components described herein can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940 that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

FIG. 10 is a schematic block diagram of a sample-computing environment 1000 that can be employed as part of conflict detection during replication in accordance with an aspect of the subject innovation. The system 1000 includes one or more client(s) 1010. The client(s) 1010 can be hardware and/or software (e.g., threads, processes, computing devices). The system 1000 also includes one or more server(s) 1030. The server(s) 1030 can also be hardware and/or software (e.g., threads, processes, computing devices). The servers 1030 can house threads to perform transformations by employing the components described herein, for example. One possible communication between a client 1010 and a server 1030 may be in the form of a data packet adapted to be transmitted between two or more computer processes. The system 1000 includes a communication framework 1050 that can be employed to facilitate communications between the client(s) 1010 and the server(s) 1030. The client(s) 1010 are operatively connected to one or more client data store(s) 1060 that can be employed to store information local to the client(s) 1010. Similarly, the server(s) 1030 are operatively connected to one or more server data store(s) 1040 that can be employed to store information local to the servers 1030.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims.

Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer implemented system comprising the following computer executable components:
a plurality of nodes with data replication therebetween; and
origination information data in form of transaction ID and peer ID embedded in data records to detect conflicts during replication among the plurality nodes.

2. The computer implemented system of claim 1 further comprising a tracing component that tracks the origination information data on reported conflicts on all peers, to enable every where detection.

3. The computer implemented system of claim 1 further comprising an inference component that facilitates designation the peer ID and the transaction ID.

4. The computer implemented system of claim 1 the origination data transferable from one node to another node in an asynchronous node.

5. The computer implemented system of claim 1, the peer ID is unique ID in history of the plurality of nodes and associated topology.

6. The computer implemented system of claim 1, the transaction ID is a unique ID relative to a peer.

7. The computer implemented system of claim 1, the peer ID and transaction ID represented as a hidden column in data records.

8. The computer implemented system of claim 2, the tracing component with every where detection of conflicts.

9. The computer implemented system of claim 1 further comprising an inference component with classifiers.

10. A computer implemented method comprising the following computer executable acts:
embedding origination data in a peer-to-peer replication system via a peer ID and a transaction ID as part of data records;
synchronizing peers in the peer-to-peer replication system; and
detecting conflicts in the peer-to-peer replication system based on the origination data.

11. The computer implemented method of claim 10 further comprising comparing a pre-version of a source node with a current version on a destination node.

12. The computer implemented method of claim 10 further comprising detecting a conflict as part of an update.

13. The computer implemented method of claim 10 further comprising detecting conflicts by peers not directly involved in the conflict.

14. The computer implemented method of claim 11 further comprising detecting existence of a match between the pre-version and the current version.

15. The computer implemented method of claim 11 further comprising deriving root conflicting updates.

16. The computer implemented method of claim 11 further comprising deriving history of conflicting changes.

17. The computer implemented method of claim 11 further comprising transferring origination data from source to target during synchronization.

18. The computer implemented method of claim 11 further comprising detecting a conflict as part of an insert via a primary key.

19. The computer implemented method of claim 11 further comprising designating the origination data based on inferences.

20. A computer implemented system comprising the following computer executable components:
means for detecting a conflict in a peer to peer replication system; and
means for tracing the conflict during replication.
